(19) United States
(12) Patent Application Publication
(10) Pub. No.: US 2005/0142307 A1
(43) Pub. Date: Jun. 30, 2005

(54) Heat transfer material

(76) Inventor: Francis Joseph Kronzer, Woodstock, GA (US)

Correspondence Address: KIMBERLY-CLARK WORLDWIDE, INC., 401 NORTH LAKE STREET, NEENAH, WI, 54956, US

(21) Appl. No.: 10/750,387

(22) Filed: Dec. 31, 2003

(51) Int. Cl. B41M 5/40

(52) U.S. Cl. 428/32.51

(57) ABSTRACT

A heat transfer material is provided. The heat transfer material includes a base layer, a release layer overlaying the base layer, and an image-receptive transfer film overlaying the release layer. The release layer includes a particulate material and provides cold-release of the image-receptive transfer film. The image-receptive transfer film adheres well to the release layer prior to application of the image-receptive transfer film to a substrate, yet the image-receptive transfer film is easily removed from the release layer after application of the film to a substrate.

### BACKGROUND OF THE INVENTION

In recent years, a significant industry has developed which involves the application of customer-selected designs, messages, illustrations, and the like (referred to collectively hereinafter as “images”) on articles of clothing, such as T-shirts, sweat shirts, and the like. These images may be commercially available products that are tailored for a specific end-use and printed on a release or transfer paper, or the customer may generate the images on a heat transfer paper. The images are transferred to the article of clothing by means of heat and pressure, after which the release or transfer paper is removed.

Heat transfer materials having an enhanced receptivity for images made by wax-based crayons, thermal printer ribbons, ink-jet printers, laser-jet printers, and impact ribbon or dot-matrix printers, are well known in the art. Typically, a heat transfer material comprises a cellulosic base sheet and an image-receptive coating on a surface of the base sheet. The image-receptive coating usually contains one or more film-forming polymeric binders, as well as, other additives to improve the transferability and printability of the coating. Other heat transfer materials comprise a cellulosic base sheet and an image-receptive coating, wherein the image-receptive coating is formed by melt extrusion or by laminating a film to the base sheet. The surface of the coating or film may then be roughened by, for example, passing the coated base sheet through an embossing roll.

Much effort has been directed at generally improving the transferability of an image-bearing film (coating) to a substrate. For example, an improved cold-peelable heat transfer material has been described in U.S. Pat. No. 5,798,179, which allows removal of the base sheet immediately after transfer of the image-bearing film (“hot peelable heat transfer material”) or some time thereafter when the film has cooled (“cold peelable heat transfer material”). Moreover, additional effort has been directed to improving the crack resistance and washability of the transferred film. The transferred film must be able to withstand multiple wash cycles and normal “wear and tear” without cracking or fading.

Cold-peelable heat transfer materials typically have a release layer that provides easy release of the backing from the image-bearing film after application of the image to the substrate. However, the easy release characteristic can often result in undesirable premature separation, peeling, or flaking of the transferable film from the release layer prior to the transfer process.

Therefore, there remains a need in the art for a cold-peelable heat transfer material having sufficient adhesion of the transfer film to the release layer prior to transfer, yet providing acceptable cold-peel release when it is time to remove the backing from the fabric after transfer of the image-bearing film.

### SUMMARY OF THE INVENTION

In accordance with one embodiment of the present invention, a heat transfer material is disclosed that includes a base layer, a release layer overlaying the base layer, which release layer includes a particulate material, and an image-receptive transfer film overlaying the release layer. The base layer may be, for example, a film, a cellulosic nonwoven web, and so forth. The release layer may further include, for example, a polymer having essentially no tack at transfer temperatures of about 177 degrees Celsius, a crosslinked polymer, and so forth.

The release layer and the image-receptive transfer film are adapted to provide cold release properties. Such cold-release properties may be imparted, for example, by using effective amount of a release-enhancing additive in the release layer. The release-enhancing additive may include, for example, a divalent metal ion salt of a fatty acid, a polyethylene glycol, a polysiloxane surfactant, a mixture thereof, and so forth. More specifically, the release-enhancing additive may include, for example, calcium stearate, a polyethylene glycol having a molecular weight of from about 2,000 to about 100,000, a siloxane-polyether surfactant, a mixture thereof, and so forth.

The image-receptive transfer film may include a film-forming binder. Further, the image-receptive transfer film may include a powdered thermoplastic polymer. In one embodiment, the image-receptive transfer film may include more than one layer. For example, the image-receptive transfer film may include a meltable layer, an ink-receptive layer, and so forth.

In one aspect, the particulate material in the release layer may be a non-meltable particulate material. The release layer may include from about 2 to about 50 percent by weight particulate material. The particulate material may include, for example, cellulose particles, silica particles, clay particles, a mixture thereof, and so forth.

In accordance with another embodiment of the present invention, a cold-peel heat transfer material is disclosed that includes a cellulosic nonwoven web, a release layer overlaying the cellulosic nonwoven web, which release layer includes from about 2% to about 50% kaolin clay particles, and an image-receptive transfer film overlaying the release layer, the image-receptive transfer film including a meltable polymer. The release layer may further include, for example, from about 10% to about 50% of a second polymer having essentially no tack at transfer temperatures of about 177 degrees Celsius or a crosslinked second polymer.

In accordance with yet another embodiment of the present invention, a method of applying an image to a substrate is disclosed that includes the steps of:
a) applying an image to a heat transfer material, the heat transfer material including:
   a base layer;
   a release layer overlaying the base layer, which release layer includes a particulate material; and
   an image-receptive transfer film overlaying the release layer;
   wherein the release layer and the image-receptive transfer film are adapted to provide the heat transfer material with cold release properties;
wherein the image is applied to the image-receptive transfer film;
b) positioning the heat transfer material adjacent a substrate with the image facing the substrate;
c) transferring the image and the image-receptive transfer film to the substrate.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a fragmentary sectional view of a first embodiment of a heat transfer material made in accordance with the present invention;

FIG. 2 is a fragmentary sectional view of a second embodiment of a heat transfer material made in accordance with the present invention;

FIG. 3 is a fragmentary sectional view of a third embodiment of a heat transfer material made in accordance with the present invention; and

FIG. 4 is a fragmentary sectional view of a fourth embodiment of a heat transfer material made in accordance with the present invention.

Repeat use of reference characters in the present specification and drawings is intended to represent same or analogous features or elements of the invention.

### DETAILED DESCRIPTION OF REPRESENTATIVE EMBODIMENTS

Reference will now be made in detail to various embodiments of the invention, one or more examples of which are provided herein. Each example is provided by way of explanation of the invention and not meant as a limitation of the invention. For example, features illustrated or described as part of one embodiment may be utilized with another embodiment to yield still a further embodiment. It is intended that the present invention include such modifications and variations as come within the scope of the appended claims and their equivalents.

### Definitions

As used herein, the term “printable” is meant to include the placement of an image on a material by any means, such as by direct and offset gravure printers, silk-screening, typewriters, laser printers, dot-matrix printers, and ink jet printers, by way of illustration. Moreover, the image composition may be any of the inks or other compositions typically used in printing processes.

The term “ink jet printable” refers to the formation of an image on a material, e.g., paper, by means of an ink jet printer. In an ink jet printer, ink is forced through a tiny nozzle (or a series of nozzles) to form droplets. The droplets may be electrostatically charged and attracted to an oppositely charged platen behind the paper. By means of electrically controlled deflection plates, the trajectories of the droplets can be controlled to hit the desired spot on the paper. Unused droplets are deflected away from the paper into a reservoir for recycling. In another method, the droplets are ejected on demand from tiny ink reservoirs by heating to form bubbles as the print head scans the paper.

The term “molecular weight” generally refers to a weight-average molecular weight unless another meaning is clear from the context or the term does not refer to a polymer. It long has been understood and accepted that the unit for molecular weight is the atomic mass unit, sometimes referred to as the “dalton.” Consequently, units rarely are given in current literature. In keeping with that practice, therefore, no units are expressed herein for molecular weights.

As used herein, the term “cellulosic nonwoven web” is meant to include any web or sheet-like material that contains at least about 50 percent by weight of cellulosic fibers. In addition to cellulosic fibers, the web may contain other natural fibers, synthetic fibers, or mixtures thereof. Cellulosic nonwoven webs may be prepared by air laying or wet laying relatively short fibers to form a web or sheet. Thus, the term includes nonwoven webs prepared from a papermaking furnish. Such furnish may include only cellulose fibers or a mixture of cellulose fibers with other natural fibers and/or synthetic fibers. The furnish also may contain additives and other materials, such as fillers, e.g., clay and titanium dioxide, surfactants, antifoaming agents, and the like, as is well known in the papermaking art.

The term “hard acrylic polymer” as used herein is intended to mean any acrylic polymer which typically has a glass transition temperature (T_{g}) of at least about 0 degrees Celsius. For example, the T_{g} may be at least about 25 degrees Celsius. As another example, the T_{g} may be in a range of from about 25 degrees Celsius to about 100 degrees Celsius. A hard acrylic polymer typically will be a polymer formed by the addition polymerization of a mixture of acrylate or methacrylate esters, or both. The ester portion of these monomers may be C₁-C₆ alkyl groups, such as, for example, methyl, ethyl, and butyl groups. Methyl esters typically impart “hard” properties, while other esters typically impart “soft” properties. The terms “hard” and “soft” are used qualitatively to refer to room-temperature hardness and low-temperature flexibility, respectively. Soft latex polymers generally have glass transition temperatures below about 0 degrees Celsius. These polymers flow too readily and tend to bond to the fabric when heat and pressure are used to effect transfer. Thus, the glass transition temperature correlates fairly well with polymer hardness.

As used herein, the term “cold release properties” means that once an image has been transferred to a substrate, such as cloth, the backing or carrier sheet may be easily and cleanly removed from the substrate after the heat transfer material has cooled to ambient temperature. That is, after cooling, the backing or carrier sheet may be peeled away from the substrate to which an image has been transferred without substantially resisting removal, leaving portions of the image on the carrier sheet, or causing imperfections in the transferred image coating.

### Detailed Description

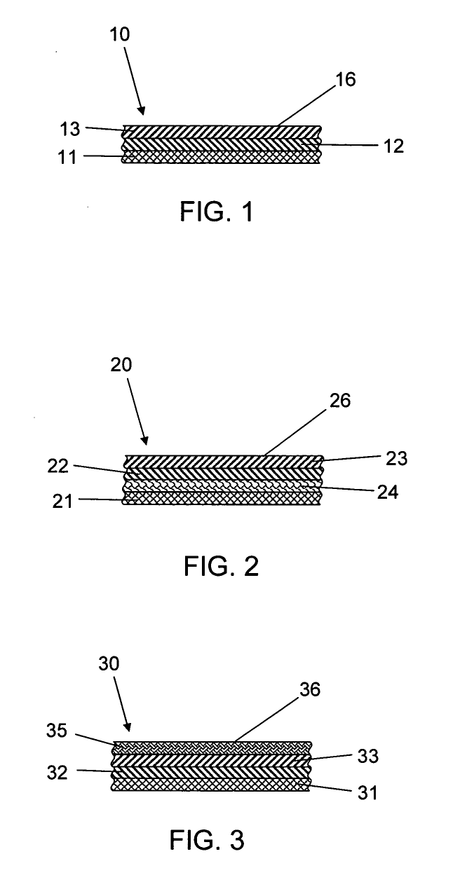

In FIG. 1, a fragmentary section of a heat transfer material 10 is shown. The heat transfer material 10 includes a backing layer 11, a release layer 12 overlaying the backing layer, and a transfer film 13 overlaying the release layer and having an exposed surface 16. An image to be transferred (not shown) is to be applied to the surface 16 of the transfer film 13.

In FIG. 2, a fragmentary section of a heat transfer material 20 is shown. The heat transfer material 20 includes a backing layer 21, a conformable layer 24 overlaying the backing layer, a release layer 22 overlaying the conformable layer, and a transfer film 23 having an exposed surface 26 overlaying the release layer. The conformable layer 24 improves the conformability of the transfer to uneven surfaces, such as fabrics. The use of meltable, conformable layers of this type has been disclosed in U.S. patent application Ser. No. 09/614,829, filed Jul. 12, 2000, the entirety of which is incorporated herein by reference. An image to be transferred (not shown) is to be applied to the surface 26 of the transfer film 23.

In FIG. 3, a fragmentary section of a heat transfer material 30 is shown. The heat transfer material 30 includes a backing layer 31, a release layer 32 overlaying the backing layer, a transfer film 33 overlaying the release layer, and an ink-receptive layer 35 having an exposed surface 36 overlaying the transfer film. The ink-receptive layer 35 improves the colorfastness, durability, and washability of the image transfer. An image to be transferred (not shown) is to be applied to the surface 36 of the ink-receptive layer 35.

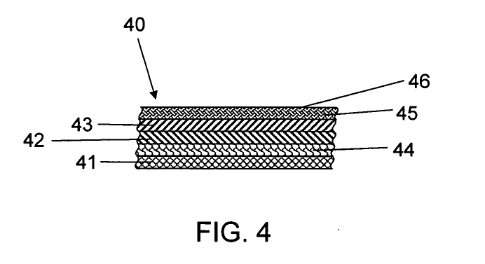

In FIG. 4, a fragmentary section of a heat transfer material 40 is shown. The heat transfer material 40 includes a backing layer 41, a conformable layer 44 overlaying the backing layer, a release layer 42 overlaying the conformable layer, a transfer film 43 overlaying the release layer, and an image-receptive layer 45 having an exposed surface 46 overlaying the transfer film. An image to be transferred (not shown) is to be applied to the surface 46 of the image-receptive layer 45.

Desirably, the heat transfer materials of the present invention have cold-release properties. Heat transfer materials having cold-release properties have been previously disclosed, for example, in U.S. Pat. Nos. 6,200,668, 5,798,179, and 6,428,878, the entireties of which are incorporated herein by reference.

As mentioned, the heat transfer material of the present invention includes a backing, or base, layer. The backing layer is flexible and has first and second surfaces. The flexible backing layer typically will be a film or a cellulosic nonwoven web. In addition to flexibility, the backing layer also should have sufficient strength for handling, coating, sheeting, other operations associated with the manufacture thereof, and for removal after transfer of the image-receptive transfer film to a substrate. The basis weight of the base layer generally may vary from about 30 to about 150 g/m². By way of example, the backing, or base, layer may be a paper such as is commonly used in the manufacture of heat transfer papers. In some embodiments, the backing layer will be a latex-impregnated paper such as described, for example, in U.S. Pat. No. 5,798,179. The backing layer is readily prepared by methods that are well known to those having ordinary skill in the art.

A release layer overlays the first surface of the backing layer. The basis weight of the release layer generally may vary from about 2 to about 30 g/m². In one embodiment, the release layer has essentially no tack at transfer temperatures (e.g., 177 degrees Celsius). As used herein, the phrase “having essentially no tack at transfer temperatures” means that the release layer does not stick to the overlying transfer film to an extent sufficient to adversely affect the quality of the transferred image. By way of illustration, the release layer may include a hard acrylic polymer or poly(vinyl acetate). As another example, the release layer may include a thermoplastic polymer having a T_{g} of at least about 25 degrees Celsius. As another example, the T_{g} may be in a range of from about 25 degrees Celsius to about 100 degrees Celsius. Suitable polymers include, for example, polyacrylates, styrene-butadiene copolymers, ethylene vinyl acetate copolymers, nitrile rubbers, poly(vinyl chloride), poly(vinyl acetate), ethylene-acrylate copolymers, and so forth, which have suitable glass transition temperatures.

In another embodiment, the release layer may include a crosslinked polymer. The cross-linked polymer may be formed from a crosslinkable polymeric binder and a crosslinking agent. The crosslinking agent reacts with the crosslinkable polymeric binder to form a 3-dimensional polymeric structure. Generally, it is contemplated that any pair of polymeric binder and crosslinking agent that reacts to form the 3-dimensional polymeric structure may be utilized. Crosslinkable polymeric binders that may be used are any that may be cross- linked to form a 3-dimensional polymeric structure. Desirable crosslinking binders include those that contain reactive carboxyl groups. Exemplary crosslinking binders that include carboxyl groups include acrylics, polyurethanes, ethylene-acrylic acid copolymers, and so forth. Other desirable crosslinking binders include those that contain reactive hydroxyl groups. Cross-linking agents that can be used to crosslink binders having carboxyl groups include polyfunctional aziridines, epoxy resins, carbodiimide, oxazolines functional polymers, and so forth. Cross-linking agents that can be used to crosslink binders having hydroxyl groups include melamine-formaldehyde, urea formaldehyde, amine-epichlorohydrin, multi-functional isocyanates and so forth.

The release layer further includes a particulate material. The particulate material may be any particulate matter that provides good adhesion of the release layer to the image-receptive transfer film prior to application of heat and pressure during the transfer process to a substrate, yet provides reduced adhesion of the release layer to the image-receptive transfer film after transfer of the image-receptive transfer film to a substrate. If the adhesion of the release layer to the image-receptive transfer film is not strong enough, flaking, cracking and premature peeling of the overlying layers can occur. If the adhesion of the release layer to the image-receptive transfer film after the transfer process is too strong, it will be difficult to remove the base layer and release layer from the substrate. It has been discovered that inclusion of a particulate material in the release layer provides the desired release properties. Desirably, the particulate material is a non-melting material. For example, the particulate material may be silica particles, cellulosic particles, clay particles, kaolin clay particles, pigment particles such as titanium dioxide or carbon black, high-melting or non-melting polymers such as polyvinyl chloride, and so forth. Any particles that provide the desirable release characteristics may be used. Additionally, the particles may be added to the release layer in any quantity or weight percentage that is sufficient to provide the desirable release characteristics. For example, the release layer may include particles from about 2 to about 50 percent by weight. Desirably, the release layer includes particles from about 5 to about 40 percent by weight, more desirably from about 10 to about 25 percent by weight, and even more desirably from about 15 to about 20 percent by weight.

The release layer also may include an effective amount of a release-enhancing additive. For example, the release enhancing additive may include a divalent metal ion salt of a fatty acid, a polyethylene glycol, a polysiloxane surfactant, or a mixture thereof. More particularly, the release-enhancing additive may include calcium stearate, a polyethylene glycol having a molecular weight of from about 2,000 to about 100,000, a siloxane polymer polyether, or a mixture thereof.

An image-receptive transfer film overlays the release layer. After imaging, the image receptive transfer film is the portion of the heat transfer material that is transferred to a substrate with the image. The image-receptive transfer film may be any film capable of being printed with the desired image and subsequently transferred with the image to the substrate. The image-receptive transfer film may be a single layer or, alternatively, may include any number of different layers. For example, the image receptive transfer film may include a meltable layer and/or an ink-compatible layer. The basis weight of the image-receptive transfer film generally may vary from about 5 to about 70 g/m².

The image-receptive transfer film may include a meltable layer that includes a thermoplastic polymer. The basis weight of the meltable layer generally may vary from about 5 to about 40 g/m². The thermoplastic polymer may be in a powdered form. The thermoplastic polymer desirably melts in a range of from about 65 degrees Celsius to about 180 degrees Celsius. The meltable layer may be formed by applying a coating of a film-forming binder over the release layer. The binder may include the powdered thermoplastic polymer, in which case the meltable layer will include from about 15 to about 80 percent by weight of the film-forming binder and from about 85 to about 20 percent by weight of the powdered thermoplastic polymer. Desirably, each of the film-forming binder and the powdered thermoplastic polymer will melt in a range of from about 65 degrees Celsius to about 180 degrees Celsius. For example, each of the film-forming binder and powdered thermoplastic polymer may melt in a range of from about 80 degrees Celsius to about 120 degrees Celsius. In addition, the powdered thermoplastic polymer may consist of particles that are from about 2 to about 50 micrometers in diameter. Desirably, the thickness of the meltable layer will be from about 12 to about 80 micrometers.

In general, any film-forming binder may be employed which meets the criteria specified herein. As a practical matter, water-dispersible ethylene-acrylic acid copolymers have been found to be especially effective film-forming binders.

Similarly, the powdered thermoplastic polymer may be any thermoplastic polymer that meets the criteria set forth herein. For example, the powdered thermoplastic polymer may be a polyolefin, polyester, ethylene-vinyl acetate copolymer, or polyamide.

The term “melts” and variations thereof are used herein only in a qualitative sense and are not meant to refer to any particular test procedure. Reference herein to a melting temperature or range is meant only to indicate an approximate temperature or range at which the film-forming binder and/or powdered thermoplastic polymer melt and flow under the conditions of the melt-transfer process described herein to result in a substantially smooth film. In so doing, such materials, and especially the powdered thermoplastic polymer, may flow partially into a fiber matrix of a fabric to which an image is being transferred.

Manufacturers' published data regarding the melt behavior of film-forming binders or powdered thermoplastic polymers correlate with the melting requirements described herein. It should be noted, however, that either a true melting point or a softening point might be given, depending on the nature of the material. For example, materials such a polyolefins and waxes, being composed mainly of linear polymeric molecules, generally melt over a relatively narrow temperature range since they are somewhat crystalline below the melting point. Melting points, if not provided by the manufacturer, are readily determined by known methods such as differential scanning calorimetry. Many polymers, and especially copolymers, are amorphous because of branching in the polymer chains or the side-chain constituents. These materials begin to soften and flow more gradually as the temperature is increased. It is believed that the ring and ball softening point of such materials, as determined by, for example, ASTM Test Method E-28, is useful in predicting their behavior in the present invention. Moreover, the melting points or softening points described are better indicators of performance in this invention than the chemical nature of the polymer.

The layers that are based on a film-forming binder may be formed on a given layer by known coating techniques, such as by roll, blade, Meyer rod, and air-knife coating procedures. The resulting heat transfer material then may be dried by means of, for example, steam-heated drums, air impingement, radiant heating, or some combination thereof.

Alternatively, the meltable layer may be a melt-extruded film. The criteria for a melt-extruded film that forms the meltable layer are generally the same as those described above for the film-forming binder and powdered thermoplastic polymer. The polymer of which a melt-extruded meltable layer is composed typically will melt in a range of from about 80 degrees Celsius to about 130 degrees Celsius. The polymer should have a melt index, as determined in accordance with ASTM Test Method D-1238-82, of at least about 25 g/10 minutes. The chemical nature of the polymer is not known to be crucial. Polymer types that satisfy these criteria and are commercially available include, by way of illustration only, copolymers of ethylene and acrylic acid, methacrylic acid, vinyl acetate, ethyl acetate, or butyl acrylate. Other polymers that may be employed include polyesters, polyamides, and polyurethanes. Waxes, plasticizers, rheology modifiers, antioxidants, antistats, antiblocking agents, and other additives may be included as either desired or necessary.

The melt-extruded meltable layer may be applied with an extrusion coater that extrudes the molten polymer through a screw into a slot die. The film exits the slot die and flows by gravity onto the release layer. The resulting coated material is passed through a nip to chill the meltable layer and bond it to the release layer. For less viscous polymers, the molten polymer may not form a self-supporting film. In these cases, the release layer may be coated by directing it into contact with the slot die or by using rolls to transfer the molten polymer from a bath to the release layer.

Optionally, the image-receptive transfer film may further include an ink-compatible layer. Because the inks employed in ink jet printers are aqueous based, an ink-compatible layer is particularly useful to make the heat transfer material ink jet printable, i.e., when an image is to be placed on the heat transfer material by an ink jet printer. The ink-compatible layer prevents or minimizes feathering of the printed image and bleeding or loss of the image when the transferred image is exposed to water. The ink-compatible layer may be, for example, the print layer described in U.S. Pat. No. 5,501,902 to Kronzer, the entirety of which is incorporated herein by reference. Thus, the ink-compatible layer may include particles of a thermoplastic polymer having largest dimensions of less than about 50 micrometers. Desirably, the particles will have largest dimensions of less than about 20 micrometers. In general, the thermoplastic polymer may be any thermoplastic polymer that meets the criteria set forth herein. Desirably, the powdered thermoplastic polymer will be selected from the group consisting of polyolefins, polyesters, polyamides, and ethylene-vinyl acetate copolymers.

The ink-compatible layer may further include from about 10 to about 50 weight percent of a film-forming binder, based on the weight of the thermoplastic polymer. Desirably, the amount of binder will be from about 10 to about 30 weight percent. In general, any film-forming binder may be employed which meets the criteria set forth herein. When the ink-compatible layer includes a cationic polymer as described below, a nonionic or cationic dispersion or solution may be employed as the binder. Suitable binders include polyacrylates, polyethylenes, and ethylene-vinyl acetate copolymers. The latter are particularly desired because of their stability in the presence of cationic polymers. The binder desirably will be heat softenable at temperatures of about 120 degrees Celsius or lower.

The basis weight of the ink-compatible layer may vary from about 5 to about 30 g/m². Desirably, the basis weight will be from about 10 to about 20 g/m². The ink-compatible layer may be applied to the image-receptive transfer film by means well known to those having ordinary skill in the art, as already described. The ink-compatible layer typically will have a melting point of from about 65 degrees Celsius to about 180 degrees Celsius.

The ink-compatible layer may contain from about 2 to about 20 weight percent of a cationic polymer, based on the weight of the thermoplastic polymer. The cationic polymer may be, for example, an amide-epichlorohydrin polymer, polyacrylamides with cationic functional groups, polyethyleneimines, polydiallylamines, and the like. When a cationic polymer is present, a compatible binder should be selected, such as a nonionic or cationic dispersion or solution. As is well known in the paper coating art, many commercially available binders have anionically charged particles or polymer molecules. These materials are generally not compatible with the cationic polymer that may be used in the ink-compatible layer. However, in some cases limited amounts of cationic polymers may be used successfully in combination with anionic binders.

The ink-compatible layer also may contain from about 0.2 to about 10 weight percent of an ink viscosity modifier, based on the weight of the thermoplastic polymer. The viscosity modifier desirably will be a poly(ethylene glycol) having a weight-average molecular weight of from about 100,000 to about 2,000,000. More desirably, the poly(ethylene glycol) will have a weight-average molecular weight of from about 100,000 to about 600,000.

Other components that may be present in the ink-compatible layer include from about 0.5 to about 5 weight percent of a surfactant, based on the weight of the thermoplastic polymer. The surfactant may be an anionic, a nonionic, or a cationic surfactant. When a cationic polymer is present in the ink-compatible layer, the surfactant is desirably not an anionic surfactant, but will be a nonionic or cationic surfactant. More desirably, the surfactant will be a nonionic surfactant. However, in the absence of the cationic polymer, an anionic surfactant may be used, if desired. Examples of anionic surfactants include, among others, linear and branched-chain sodium alkylbenzenesulfonates, linear and branched-chain alkyl sulfates, and linear and branched-chain alkyl ethoxy sulfates. Cationic surfactants include, by way of illustration, tallow trimethylammonium chloride. Examples of nonionic surfactants include, again by way of illustration only, alkyl polyethoxylates, polyethoxylated alkylphenols, fatty acid ethanol amides, complex polymers of ethylene oxide, propylene oxide, alcohols, and polysiloxane polyethers.

Finally, the heat transfer material may further include a conformable layer overlaying the base layer and underlying the release layer, thereby being located between the base layer and the release layer. In general, the conformable layer may include an extrusion coated polymer that melts in a range of from about 65 degrees Celsius to about 180 degrees Celsius as described above for the meltable layer. As an example, the conformable layer may be an extrusion coating of ethylene vinyl acetate. Alternatively, the conformable layer may include a film-forming binder and/or a powdered thermoplastic polymer as described for the image-receptive transfer film. The basis weight of the conformable layer generally may vary from about 5 to about 60 g/m².

If desired, any of the foregoing layers or films may contain other materials, such as processing aids, release agents, pigments, deglossing agents, antifoam agents, and the like. The use of these and similar materials is well known to those having ordinary skill in the art.

The present invention may be better understood with reference to the examples that follow. Such examples, however, are not to be construed as limiting in any way either the spirit or scope of the present invention. In the examples, all parts are parts by weight unless stated otherwise.

### EXAMPLES

Cold-release heat transfer papers were prepared, each paper having a base layer, a conformable layer overlaying the base layer, a release layer overlaying the conformable layer, and an image-receptive transfer film overlaying the release layer. The image-receptive transfer film included a meltable layer overlaying the release layer and an ink-compatible layer overlaying the meltable layer. The base layer was a supersmooth bond paper having a basis weight of 86.3 g/m² (available as Avon White from Kimberly-Clark Corporation of Dallas, Tex.). The conformable layer was a 1.8 mil layer of ethylene vinyl acetate (available as Elvax 3200 from DuPont) extrusion coated on the base layer.

Samples were prepared having three different release layers for comparison. In Sample A, the release layer was a mixture of 100 dry parts acrylic latex (available as Rhoplex SP-100 from Rohm & Haas of Philadelphia, Pa.) and 5 dry parts aziridine crosslinking agent (available as XAMA 7 from Sybron Chemicals, Inc. of Birmingham, N.J.) coated on the conformable layer as a 20% solids aqueous dispersion and dried for about 2 minutes at 100 degrees Celsius to a basis weight of 8.3 g/m².

In Sample B, the release layer was a mixture of 100 dry parts acrylic latex, 5 dry parts aziridine crosslinking agent, and 2.5 dry parts water soluble silicone surfactant (available as Dow S-190 from The Dow Chemical Company) coated on the conformable layer as a 20% solids aqueous dispersion and dried for about 2 minutes at 100 degrees Celsius to a basis weight of 8.3 g/m².

In Sample C, the release layer was a mixture of 100 dry parts acrylic latex, 5 dry parts aziridine crosslinking agent, 2.5 dry parts water soluble silicone surfactant, and 20 dry parts kaolin clay (available as Ultrawhite 90 from Engelhard of Iselin, N.J.) coated on the conformable layer as a 20% solids aqueous dispersion and dried for about 2 minutes at 100 degrees Celsius to a basis weight of 8.3 g/m².

For Samples A, B, and C, the meltable layer was a mixture of 100 dry parts ethylene acrylic acid copolymer (available as Michem Prime 4983 from Michelman Inc.), 50 dry parts powdered polyamide (available as Orgasol 3510 EXD from Elf Atochem North America Inc. of Philadelphia, Pa.), 50 dry parts 1,4 cyclohexane dimethanol dibenzoate (available as Benzoflex 352 from Velsicol Chemical Corporation of Rosemont, Ill.) micronized to an average size of about 8 microns, 40 dry parts powdered polyethylene wax (available as Micropowders MP 635 G from Micro Powders, Inc. of Tarrytown, N.Y.), 4.5 dry parts nonionic surfactant (available as Tergitol 15-S-40 from BASF Corporation of Mount Olive, N.J.), and 1 dry part of polyethylene oxide (available as Polyox N60 from The Dow Chemical Company) coated as a 20% solids aqueous dispersion and dried for about 2 minutes at 100 degrees Celsius on the release layer at 15 g/m².

To test the adhesion of the meltable layer to the release layer, peel tests were performed prior to application of the ink-compatible layer. The peel test is best performed before application of the ink-compatible layer because the ink-compatible layer contains very little binder and thus has a tendency to fail cohesively during the peel test. However, cohesive failure of the ink-compatible layer during a peel test is not implicated in the premature delamination of the underlying meltable layer from the release layer that the present invention addresses.

The peel test was performed by applying a plastic packaging tape (available as Highland™ 3710 from 3M of St. Paul, Minn.) to the exposed surface of the meltable layer on Samples A-C. The samples were then cut into 1-inch wide strips. Peeling of the tape and meltable layer from the release layer was initiated. The force required to peel the meltable layer from the release layer was measured using an Instron tensile tester. The two layers, i.e., the meltable layer (with the tape attached) and the release layer (with the base layer) were placed in the respective jaws of the tensile tester. During the test, the separation rate was 300 millimeters per minute at an angle of 180 degrees. For Sample B, a peel force of 10 grams per inch was measured. For Samples A and C, the peel force was not measurable because the sample broke before the layers would peel apart.

For Samples A, B, and C, the ink-compatible layer was a mixture of 100 dry parts powdered polyamide, 70 dry parts ethylene acrylic acid copolymer, 40 dry parts 1,4 cyclohexane dimethanol dibenzoate, 6 dry parts nonionic surfactant (available as Triton X 100 from The Dow Chemical Company), 6 dry parts cationic polymer (available as Glascol F 207 from Ciba Specialty Chemicals of Suffolk, Va.), and 6 dry parts of polyethylene oxide (available as Polyox N80 from The Dow Chemical Company) coated as a 20% solids aqueous dispersion and dried for about 5 minutes at 60 degrees Celsius on the cold-peelable transfer layer at 18.8 g/m².

Thus, Samples A, B, and C were prepared having essentially the same constructions with the exception being the three different compositions of the respective release layers.

Ease of cold-peeling the three heat transfer papers after attachment of the image-receptive transfer film to a substrate was determined according to the following procedure. For each sample, the heat transfer paper was placed adjacent a piece of white, 100% cotton, T-shirt material with the image-receptive transfer film facing toward the fabric. The heat transfer paper and fabric were placed in a standard heat press (Hotronix model XSW available from Stahls' Hotronix of Masontown, Pa.) at 177 degrees Celsius for thirty seconds at a pressure setting of seven. After removing the samples from the heat press, the samples were allowed to cool for the periods of time specified in Table 1; 5 minutes, 15 minutes, 1 hour, and 1 day. The peel strength required to peel the base layer and release layer from the fabric was tested after the cooling period by cutting the fabric/paper into 1-inch strips and performing the peel test as described above. The peel test results are summarized in Table 1.

TABLE 1

| | 5 min. peel | 15 min. peel | 1 hr. peel | 1 day peel |
|---|---|---|---|---|
| Sample A | 37 | 31 | 29 | 66 |
| Sample B | 12 | 12 | 22 | 39 |
| Sample C | 7 | 6 | 18 | 51 |

As noted above, only Samples A and C had the desirably high peel strengths desired to inhibit cracking and peeling of the image-receptive transfer film prior to the transfer process. As can be seen in Table 1, only Samples B and C had the desirably low peel strength after the transfer process that allows easy removal of the base layer and release layer. Thus, only sample C has both the high peel strength prior to heating in the transfer process and the low peel strength after the heating and cooling in the transfer process. The low peel strengths of samples B and C persist for at least an hour, well beyond the time it takes to cool the transfer and remove the base layer and release layer.

It should be appreciated by those skilled in the art that various modifications or variations can be made in the invention without departing from the scope and spirit of the invention. It is intended that the invention include such modifications and variations as come within the scope of the appended claims and their equivalents.

1. A heat transfer material comprising:
a base layer;
a release layer overlaying the base layer, which release layer comprises a particulate material; and
an image-receptive transfer film overlaying the release layer;
wherein the release layer and the image-receptive transfer film are adapted to provide cold release properties.

2. The heat transfer material of claim 1, further wherein the base layer is selected from the group consisting of films and cellulosic nonwoven webs.

3. The heat transfer material of claim 1, further wherein the base layer includes a latex-impregnated cellulosic nonwoven web.

4. The heat transfer material of claim 1, further wherein the release layer further comprises a polymer having essentially no tack at transfer temperatures of about 177 degrees Celsius.

5. The heat transfer material of claim 4, further wherein the polymer is selected from the group consisting of acrylic polymers and poly(vinyl acetate).

6. The heat transfer material of claim 1, further wherein the release layer further comprises a crosslinked polymer.

7. The heat transfer material of claim 1, further wherein the release layer further comprises an effective amount of a release-enhancing additive.

8. The heat transfer material of claim 7, further wherein the release-enhancing additive is selected from the group consisting of a divalent metal ion salt of a fatty acid, a polyethylene glycol, a polysiloxane surfactant, and mixtures thereof.

9. The heat transfer material of claim 7, further wherein the release-enhancing additive is selected from the group consisting of calcium stearate, a polyethylene glycol having a molecular weight of from about 2,000 to about 100,000, a siloxane-polyether surfactant, and mixtures thereof.

10. The heat transfer material of claim 1, further wherein the image-receptive transfer film comprises a film-forming binder.

11. The heat transfer material of claim 1, further wherein the image-receptive transfer film comprises a powdered thermoplastic polymer and a film-forming binder.

12. The heat transfer material of claim 1, further wherein the particulate material is non-meltable.

13. The heat transfer material of claim 1, further wherein the release layer further comprises from about 2 to about 50 percent by weight particulate material.

14. The heat transfer material of claim 1, further wherein the particulate material is selected from the group consisting of cellulose particles, silica particles, clay particles, and mixtures thereof.

15. The heat transfer material of claim 1, wherein the image-receptive transfer film comprises a meltable layer.

16. The heat transfer material of claim 1, wherein the image-receptive transfer film comprises an ink-compatible layer.

17. The heat transfer material of claim 16, wherein the ink-compatible layer comprises a film-forming binder and a powdered thermoplastic polymer.

18. A cold-peel heat transfer material comprising:
a cellulosic nonwoven web; and
a release layer overlaying the cellulosic nonwoven web, which release layer comprises from about 10% to about 50% of a first polymer having essentially no tack at transfer temperatures of about 177 degrees Celsius and from about 2% to about 50% kaolin clay particles; and
an image-receptive transfer film overlaying the release layer, the image-receptive transfer film comprising a meltable second polymer;
wherein the release layer and the image-receptive transfer film are adapted to provide cold release properties.

19. A method of applying an image to a substrate, the method comprising the steps of:
a) applying an image to a heat transfer material, the heat transfer material comprising:
a base layer;
a release layer overlaying the base layer, which release layer comprises a particulate material; and
an image-receptive transfer film overlaying the release layer;
wherein the release layer and the image-receptive transfer film are adapted to provide the heat transfer material with cold release properties;
wherein the image is applied to the image-receptive transfer film;
b) positioning the heat transfer material adjacent a substrate with the image facing the substrate;
c) transferring the image and the image-receptive transfer film to the substrate.

20. The method of claim 19, wherein the particulate material is non-meltable.

21. The method of claim 19, wherein the release layer further comprises from about 2 to about 50 percent by weight particulate material.

22. The method of claim 19, wherein the particulate material is selected from the group consisting of cellulose particles, silica particles, clay particles, and mixtures thereof.
